(19) United States
(12) Patent Application Publication
(10) Pub. No.: US 2005/0103643 A1
(43) Pub. Date: May 19, 2005

(54) Fresh water generation system and method

(76) Inventor: Steven Shoup, Eagle, ID (US)

Correspondence Address: DLA PIPER RUDNICK GRAY CARY US, LLP, 2000 UNIVERSITY AVENUE, E. PALO ALTO, CA, 94303-2248, US

(21) Appl. No.: 10/713,854

(22) Filed: Nov. 14, 2003

(51) Int. Cl. C02F 1/461

(52) U.S. Cl. 205/742

(57) ABSTRACT

A fresh water generation system and method are provided wherein the system is self-contained and non-polluting. The system may include an electrolysis cell, an energy generation cell and a power source/supply. The system accepts non-potable water sources, such as seawater, and generates fresh potable drinking water.

### FIELD OF THE INVENTION

The invention relates generally to a system and method for generating fresh water and in particular to a system for generating fresh water from contaminated/dirty input liquid, such as seawater.

### BACKGROUND OF THE INVENTION

It is well known that fresh water is essential to the survival of human beings. For example, a human being may be able to survive a week or more without food, but cannot survive more than several days without water. Therefore, it is desirable to ensure a steady, adequate source of fresh water which is potable. In some environments, it is difficult to ensure the adequate supply of potable water. For example, cities and people located in arid areas often must struggle to find an adequate source of potable water. Often, these cities in the arid areas are located near a source of non-potable water. For example, the city may be located near an ocean. It is well known that one can extract potable water from the seawater. There are many different techniques utilized for the desalination process in which the seawater is converted into potable, drinking water. The limitation with most of these techniques is that the system has one or more moving parts that will eventually wear out and need to be replaced. It is desirable to provide a system that has fewer moving parts so that the system is able to operate with minimal human supervision and minimal repair cost. Furthermore, most typical systems require a large amount of power to operate as the processes being used require a large amount of input power. A system therefore must have a connection to a large source of power which unnecessarily increases the complexity and cost of the system. Thus, it is desirable to provide a system that is capable of generating some/most of its own power requirements.

Thus, it is desirable to provide a fresh water generation system and method that overcomes the above limitations and it is to this end that the present invention is directed.

### SUMMARY OF THE INVENTION

A fresh water generation system and method are described in which fresh potable water is generated from a non-potable water source, including but not limited to brackish water or sea water. The fresh water generation system comprises an electrolysis cell and a power generation cell. The electrolysis cell separates the sea water into hydrogen and oxygen gases so that the dissolved salts and particulate settles out and is flushed away. The electrolysis cell is provided with electrical power to perform the electrolysis. The hydrogen and oxygen gases are passed to the fuel cell. The fuel cell, in the preferred embodiment, is a hydrogen fuel cell that combines hydrogen and oxygen to generate energy and also forms pure water which is the output pure water. The energy generated from the recombination of the hydrogen and oxygen into water is fed to a power supply wherein the system may be self-sustaining and able to generate sufficient energy to power the electrolyis cell. The power supply may also generate its own source of power, such as from solar energy. In accordance with the invention, the fresh water generation system may be packaged together into a crate, for example, so that it may be placed in a hostile environment, such as the desert, set-up and run with little or no maintenance required.

Thus, in accordance with the invention a fresh water generation system that generates fresh water from a liquid reservoir is provided. The system has a cell that receives an input liquid and disassociates the input liquid into hydrogen gas and oxygen gas. The cell has a first electrode that generates the hydrogen gas, a second electrode that generates the oxygen gas and an output that returns the excess input liquid to a reservoir and cleans contaminants out of the cell. The system further comprises a second cell that receives the hydrogen and oxygen gases from the first cell, the second cell comprising an anode, a cathode and a catalyst separating the anode and cathode, wherein the hydrogen gas is provided to the anode and the oxygen gas is provided to the cathode and the hydrogen gas is separated into electrons and protons in the presence of the catalyst, the protons passing through the catalyst to the oxygen gas and recombining with the oxygen gas to produce potable water and electricity that is fed back into the system to provide energy for the electrolysis process.

In accordance with another aspect of the invention, a fresh water generation method for generating fresh water from a liquid reservoir is described. The method comprises disassociating the input liquid into hydrogen gas and oxygen gas using a cell having a first electrode that generates the hydrogen gas, a second electrode that generates the oxygen gas. Then, contaminants are flushed out of the cell and excess input liquid is returned to the reservoir. Next, energy is generated during a recombination of the generated hydrogen and oxygen gases and potable water is generated as a by-product of the energy generation.

In accordance with yet another aspect of the invention, a method for installing and operating a fresh water generation system is provided. First, a fresh water generation system is placed into a location. The fresh water generation system has a cell that receives an input liquid from an input port and disassociates the input liquid into hydrogen gas and oxygen gas, the cell having a first electrode that generates the hydrogen gas, a second electrode that generates the oxygen gas and an output that returns the excess input liquid to a reservoir and cleans contaminants out of the cell, and a second cell that receives the hydrogen and oxygen gases from the first cell, the second cell comprising an anode, a cathode and a catalyst separating the anode and cathode, wherein the hydrogen gas is provided to the anode and the oxygen gas is provided to the cathode and the hydrogen gas is separated into electrons and protons in the presence of the catalyst, the protons passing through the catalyst to the oxygen gas and recombining with the oxygen gas to produce potable water. Next, an input liquid stream is attached to the input port of the fresh water generation system and the fresh water generation system is operated with minimal maintenance since the fresh water generation system has few moving parts.

### BRIEF DESCRIPTION OF THE DRAWINGS

FIG. 1 is a diagram illustrating a fresh water generation system in accordance with the invention;

FIG. 2 illustrates more details of the electrolysis cell in accordance with the invention;

FIG. 3 illustrates more details of the energy generation cell in accordance with the invention;

FIG. 4 illustrates the energy balance of the fresh water generation system shown in FIG. 1; and

FIG. 5 is a diagram illustrating an implementation of a fresh water generation system in accordance with the invention.

### DETAILED DESCRIPTION OF A PREFERRED EMBODIMENT

The invention is particularly applicable to the generation of fresh water from seawater and it is in this context that the invention will be described. It will be appreciated, however, that the fresh water generation system and method in accordance with the invention has greater utility since it may be used with other input liquids, such as sewage, dirty water, contaminated water, etc. Now, the fresh water generation system and method in accordance with the invention will be described in more detail.

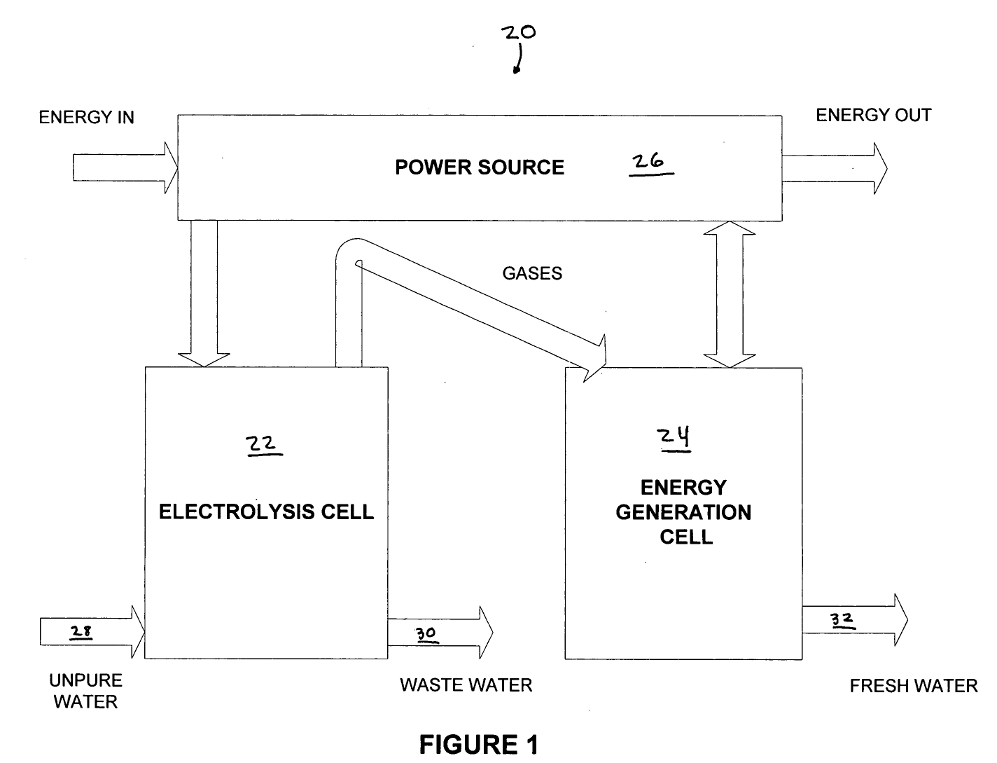

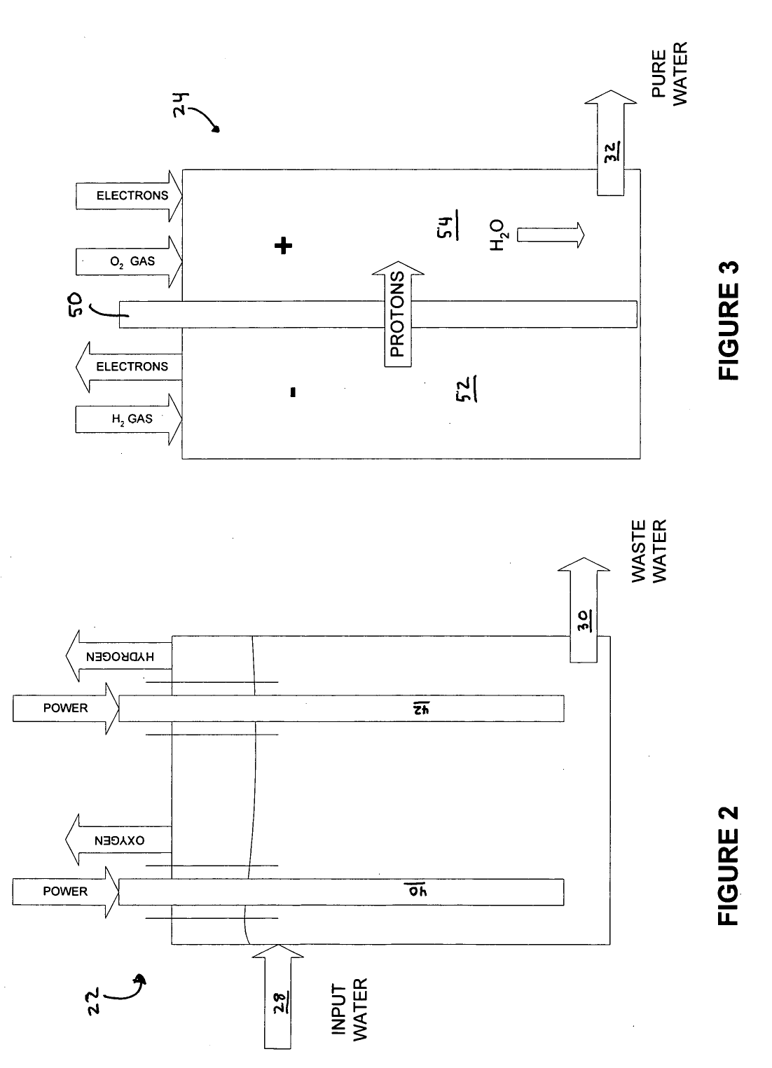

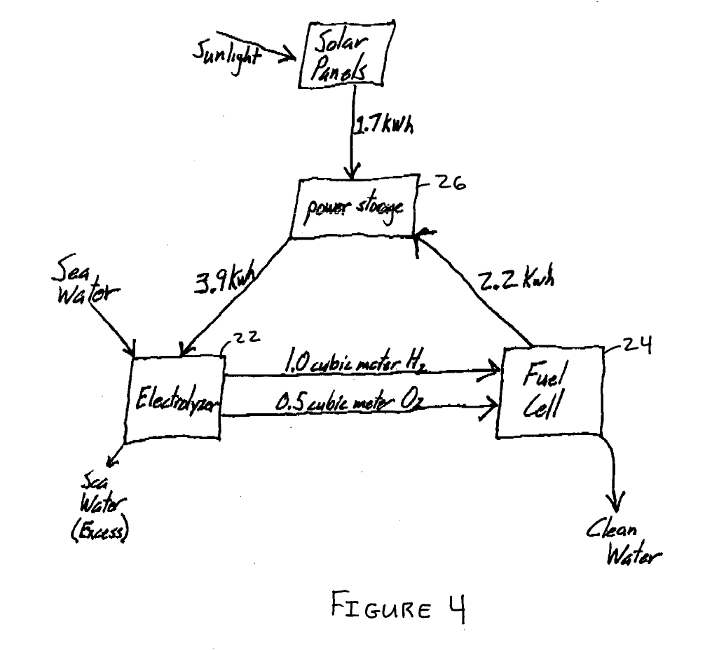

FIG. 1 is a diagram illustrating a fresh water generation system 20 in accordance with the invention. The system accepts an non-potable input liquid from a reservoir, such as seawater, generates fresh, potable water and is somewhat self-sustaining in that the system generates some/most of its own power requirements. The system 20 comprises an electrolysis cell 22, an energy generation cell 24 and a power source 26. The electrolysis cell 22 disassociates an input liquid 28, such as seawater, brackish water or any other non-potable water source in this example, into its constituent gases which are collected and provided to the energy generation cell 24 as shown. In the preferred embodiment, the seawater/brackish water is disassociated into hydrogen gas and oxygen gas (as described below in more detail with reference to FIG. 2). As shown, the electrolysis cell 22 receives some power from the power source. As a result of the electrolysis process, a water stream 30 is generated that may be recycled and used to flush the solid particulate from the electrolysis cell. For example, the waste and salt in the seawater, that has been disassociated into hydrogen and oxygen gases, may attach to other water molecules in the remaining seawater and then discharged back into the reservoir. The energy generation cell 24 receives the gases from the electrolysis cell 22 and generates a stream 32 of potable water. The energy generation cell 24 utilizes the gases from the electrolysis cell to generate the output stream 32 as described below in more detail with reference to FIG. 3. The energy generation cell 24 may receive some power from the power source 26 and may provide some power to the power source as shown by the two-ended arrow between the energy generation cell 24 and the power source 26.

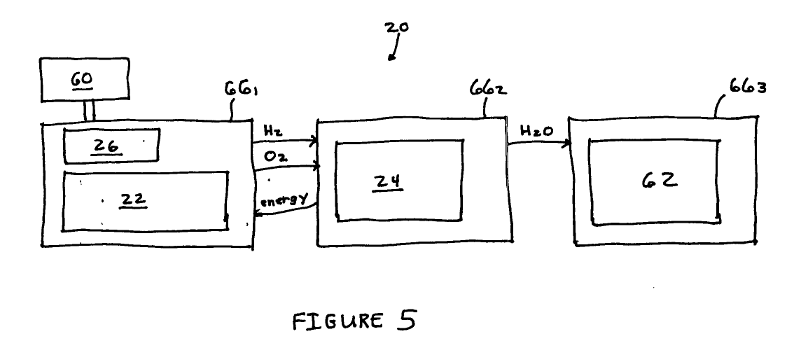

The power source may be various devices that are capable to storing energy for an extended period of time. For example, the power source may be a battery or other energy storage device. The power source may receive input energy, such as from a solar energy cell or solar energy generation system in a preferred embodiment, and may also output some energy as shown. The precise amounts of input energy required and output energy generated depends on the operation of the cells 22, 24. However, in accordance with the invention, the system 20 generates some predetermined portion of its own energy so that it is a mostly self-contained fresh water generation system as described below with reference to FIG. 4. Thus, the system 20 shown in FIG. 1 can be housed in a contained area/container so that it may be placed into an environment and operate with minimal set-up and maintenance. For example, the system may be placed at a location, its input attached to an input stream of liquid, such as the ocean, its waste stream output connected to a recycling stream, and its output to an output pipe for the fresh water. The system may also include solar cells that generate the requisite amount of energy input into the system 20. Now, more details of the electrolysis cell will be described.

FIG. 2 illustrates more details of the electrolysis cell 22 in accordance with the invention. The electrolysis cell 22 comprises a first electrode 40 and a second electrode 42 wherein the first and second electrodes 40, 42 are oppositely charged. These electrodes of the electrolysis cell may also be known as a cathode and anode as is well known. In accordance with the invention, the input stream 28 maintains the level of liquid in the electrolysis cell 22 at a predetermined level so that both electrodes are covered with liquid. In some embodiments, a catalyst may be inserted into the input stream 28. For example, an input liquid without sufficient salt (ions) may require the addition of a catalyst. Each electrode is charged by power from the power source 26 (not shown). In accordance with the invention, the liquid in the cell is disassociated into its constituent parts as a result of the oppositely charged electrodes. In the preferred embodiment, oxygen gas is generated at one electrode and hydrogen gas is generated at the other electrode. In accordance with the invention, it is anticipated that the input stream 28 will flow constantly through the cell 22 and exit the cell as waste liquid 30 (and may be returned to the input source, such as the ocean) so that any contaminants that remain in the cell 22 following the disassociation of the liquid are flushed out of the cell 22. It should be noted that the cell 22 contain few moving parts (such as the gas and liquid valves) and should require minimal maintenance. In accordance with the invention, the electrolysis cell 22 may be replaced with a Brown's gas electrolysis cell. A description of a commercially available Brown's Gas cell may be found at www.watertorch.com. Now, the energy generation cell 24 will be described in more detail.

FIG. 3 illustrates more details of the energy generation cell 24 in accordance with the invention. The energy generation cell 24 generates energy, but also produces pure water 32 as shown through a pollution-less process. As shown, the cell 24 comprises a barrier 50 that separates two sides of the cell. In a preferred embodiment of the invention, the barrier 50 is a platinum plate, although other substrates may also be used. In accordance with the invention, the hydrogen gas (H₂) is fed into a negative charge side 52 of the cell (the anode) while oxygen gas (O₂) is fed into a positive charge side 54 of the cell (the cathode). In accordance with the invention, the platinum acts as a catalyst and activates the hydrogen so that the hydrogen gas separates into protons and electrons wherein the protons and electrons take different paths to the cathode. The electrons exit the cell through a wire and therefore generate a flow of electricity. The protons migrate through the platinum plate to the cathode and reunite with the oxygen gas. As a result, water is generated (from the combination of the proton and oxygen gas) and energy is generated. Thus, as shown, the cell 24 generates the pure water stream 32. In combination with the electrolysis cell 22 described above, the system generates pure water and energy from the input stream 28 with few moving parts and minimal maintenance. The energy generation cell 24 may preferably be an alkaline fuel cell. In other embodiments, the energy generation cell may be a proton exchange membrane fuel cell.

FIG. 4 is a diagram illustrating the energy balance of an example of the fresh water generation system in accordance with the invention. In particular, each element of the fresh water generation system shown in FIG. 4 has particular characteristics and energy levels of typical off the shelf components that are commercially available. When better components are available, the energy balance of the fresh water system will be such that less/no solar energy will be needed to operate the system. In the example shown in FIG. 4, the system may generate approximately 120 gallons of fresh water per hour wherein approximately 1 gallon of fresh water is produced for each cubic meter of hydrogen gas. As shown, the electrolysis cell 22 may consume 3.9 Kwh and produce 1.0 m³ of H₂ and 0.5 m³ of O₂. The fuel cell 24 may generate the fresh water and generate 2.2 Kwh of energy that is fed back into the power storage 26. Thus, an outside energy source, such as solar cells/panels, may generate 1.7 Kwh of power to balance the energy of the system. Assuming that a typical solar panel produces 120 watts per second/m² at a 12% efficiency, the system requires 14.2 m² of solar panels. As solar panels become more efficient, the size of the required solar panels will decrease. In addition, as the energy consumption of the electrolysis cell is reduced and/or the energy generation of the fuel cell increases (as the technology of each improves), the size of the required solar panels will be further reduced. For example, the electrolysis cell 22 used in the example may be replaced by a Brown's gas cell (See, for example, www.watertorch.com) which consumes less energy. In addition, the fuel cell may be replaced with an alkaline fuel cell that generates more energy for a predetermined amount of hydrogen gas.

FIG. 5 is a diagram illustrating an example of an implementation of the fresh water generation system 20 in which the system may be housed in one or more units 66₁-66₃ and connected together to generate fresh water. The units 66₁-66₃ may be placed into a single container or each unit may be located in a separate container. In a preferred embodiment, each container may be a typical steel container that may be carried on a truck or stacked and transported via a ship wherein the containers may be placed into a location, such as the desert, connected together and start producing fresh water. In the example shown in FIG. 5, the electrolysis cell 22 and the power source/supply 26 may be housed in the first unit 66₁ wherein the unit also has one or more solar panels 60 attached to it, the energy generation cell 24 may be housed in the second unit 66₂ and a water storage unit 62 may be housed in the third unit 66₃. Then the various connections between each unit are made as shown so that the fresh water generation system 20 is housed in the three units shown. In accordance with the invention, the fresh water generation system may have any number of units and containers. For example, for a large fresh water generation project, there may be multiple units with the electrolysis cell, multiple units with the energy generation cell and multiple units with water storage so that the fresh water generation system in accordance with the invention may be easily scaled to meet any water need.

While the foregoing has been with reference to a particular embodiment of the invention, it will be appreciated by those skilled in the art that changes in this embodiment may be made without departing from the principles and spirit of the invention, the scope of which is defined by the appended claims.

1. A fresh water generation system that generates fresh water from a liquid reservoir, comprising:
a cell that receives an input liquid and disassociates the input liquid into hydrogen gas and oxygen gas, the cell having a first electrode that generates the hydrogen gas, a second electrode that generates the oxygen gas and an output that returns the excess input liquid to a reservoir and cleans contaminants out of the cell; and
a second cell that receives the hydrogen and oxygen gases from the first cell, the second cell comprising an anode, a cathode and a catalyst separating the anode and cathode, wherein the hydrogen gas is provided to the anode and the oxygen gas is provided to the cathode and the hydrogen gas is separated into electrons and protons in the presence of the catalyst, the protons passing through the catalyst to the oxygen gas and recombining with the oxygen gas to produce potable water.

2. The system of claim 1 further comprising a power supply that supplies power to the first cell and receives power from the second cell.

3. The system of claim 2, wherein the power supply further comprises an energy generation system that generates energy.

4. The system of claim 3, wherein the energy generation system comprises a solar energy system.

5. The system of claim 1, wherein the catalyst further comprises a carbon fiber platinum plate.

6. The system of claim 1, wherein the input liquid further comprises a non-potable water source.

7. The system of claim 6, wherein the non-potable water source further comprises one of seawater and brackish water.

8. The system of claim 1, wherein the output flushes the dissolved material in the input liquid that separates during the disassociation process back to the reservoir.

9. A fresh water generation method for generating fresh water from a liquid reservoir, comprising:
disassociating the input liquid into hydrogen gas and oxygen gas using a cell having a first electrode that generates the hydrogen gas, a second electrode that generates the oxygen gas;
flushing contaminants out of the cell and returning the excess input liquid to the reservoir;
generating energy during a recombination of the generated hydrogen and oxygen gases; and
generating potable water as a by-product of the energy generation.

10. The method of claim 9 further comprising supplying power via a power supply to the disassociation process and receiving power from recombination process.

11. The method of claim 10 further comprising generating energy in addition to the energy generated by the recombination process.

12. The method of claim 11, wherein energy generation further comprises generating energy from solar radiation.

13. A method for installing and operating a fresh water generation system, the method comprising:
placing a fresh water generation system into a location, the fresh water generation system comprising a cell that receives an input liquid from an input port and disassociates the input liquid into hydrogen gas and oxygen gas, the cell having a first electrode that generates the hydrogen gas, a second electrode that generates the oxygen gas and an output that returns the excess input liquid to a reservoir and cleans contaminants out of the cell, and a second cell that receives the hydrogen and oxygen gases from the first cell, the second cell comprising an anode, a cathode and a catalyst separating the anode and cathode, wherein the hydrogen gas is provided to the anode and the oxygen gas is provided to the cathode and the hydrogen gas is separated into electrons and protons in the presence of the catalyst, the protons passing through the catalyst to the oxygen gas and recombining with the oxygen gas to produce potable water;
attaching an input liquid stream to the input port of the fresh water generation system; and
operating the fresh water generation system with minimal maintenance since the fresh water generation system has few moving parts.

14. The method of claim 13 further comprising housing the first cell and a power source in a first unit, housing the second cell in a second unit and housing a water storage unit in a third unit wherein the first, second and third units are connected to each other.

15. The method of claim 14 further comprising housing the first, second and third units in a container.

16. The method of claim 14 further comprising housing the first unit in a first container, the second unit in a second container and the third unit in a third container.
